(19) United States
(12) Patent Application Publication
(10) Pub. No.: US 2022/0108663 A1
(43) Pub. Date: Apr. 7, 2022

(54) DISPLAY DEVICE

(71) Applicant: Japan Display Inc., Tokyo (JP)

(72) Inventors: Keitaro NUMATA, Tokyo (JP); Shinichi IWASAKI, Tokyo (JP); Tamotsu UEKURI, Tokyo (JP)

(73) Assignee: Japan Display Inc., Tokyo (JP)

(21) Appl. No.: 17/553,202

(22) Filed: Dec. 16, 2021

Related U.S. Application Data
(63) Continuation of application No. PCT/JP2020/015575, filed on Apr. 6, 2020.

(30) Foreign Application Priority Data
Jun. 21, 2019 (JP) 2019-115628

(51) Int. Cl. G09G 3/36

(52) U.S. Cl. CPC G09G 3/36; G09G 2360/10; G09G 2310/0286; G09G 2310/08; G09G 2330/021

(57) ABSTRACT

According to one embodiment, a display device includes a panel and a controller. The panel includes a pixel including a pixel memory and a first circuit which is controlled by a polarity control signal and supplies a polarity signal to the pixel. The panel includes a first mode and a second mode. The first mode displays video using a video signal continuously supplied from the controller. The second mode displays video using a video signal recorded in a pixel memory. The controller includes a second circuit and a microcomputer. The second circuit outputs the video signal. The microcomputer controls the second circuit. In the first mode, the second circuit outputs the polarity control signal. In the second mode, the microcomputer outputs the polarity control signal.

### CROSS-REFERENCE TO RELATED APPLICATIONS

This application is a Continuation application of PCT Application No. PCT/JP2020/015575, filed Apr. 6, 2020 and based upon and claiming the benefit of priority from Japanese Patent Application No. 2019-115628, filed Jun. 21, 2019, the entire contents of all of which are incorporated herein by reference.

### FIELD

Embodiments described herein relate generally to a liquid crystal display device.

### BACKGROUND

In recent years, liquid crystal panels known as memory-in-pixel (MIP) liquid crystals have begun to spread. In this liquid crystal panel, each pixel comprises a memory, and for example, in the case of displaying a still image, the liquid crystal panel can use video signals recorded in the memory to display video; therefore, excels in saving power consumption.

A polarity signal is supplied to each pixel of the liquid crystal panel to prevent deterioration caused by applying a DC voltage to a liquid crystal composition. The supply of the polarity signal to each pixel is controlled by a video signal control circuit, which outputs video signals, in a controller that controls the liquid crystal panel.

Therefore, the controller cannot stop the video signal control circuit even during a period in which the liquid crystal panel displays an image using the video signal recorded in the memory.

### BRIEF DESCRIPTION OF THE DRAWINGS

FIG. 1 is an overall view of a system of a display device of an embodiment.

FIG. 2 is a detailed view of a liquid crystal display panel of the display device of the embodiment.

FIG. 3 is a block diagram of a latch circuit of the display device of the embodiment.

FIG. 4 is a diagram showing a latch circuit unit of the display device of the embodiment.

FIG. 5 is a diagram showing a buffer circuit of the display device of the embodiment.

FIG. 6 is a diagram showing a pixel circuit of the display device of the embodiment.

FIG. 7 is a diagram showing a linkage between a system control circuit and a video signal control circuit relating in relation to outputting a polarity signal in the display device of the embodiment.

FIG. 8 is a diagram showing an example of a circuit for exclusively and selectively outputting signals from the video signal control circuit or the system control circuit in the display device of the embodiment.

FIG. 9 is a timing chart showing an output timing of various signals when switching between a controller mode and a memory mode of the display device of the embodiment.

FIG. 10 is a polarity signal timing chart in the display device of the embodiment.

FIG. 11 is a diagram showing a polarity signal shift register and a memory circuit in the display device of the embodiment.

FIG. 12 is a timing chart of the polarity signal shift register and the memory circuit in the display device of the embodiment.

FIG. 13 is a diagram showing a first example of a circuit in the periphery of a pixel of the display device of the embodiment.

FIG. 14 is a diagram showing a first example of an arrangement of pixel electrodes of the display device of the embodiment.

FIG. 15 is a diagram showing a second example of the circuit in the periphery of the pixel of the display device of the embodiment.

FIG. 16 is a diagram showing a second example of the arrangement of pixel electrodes of the display device of the embodiment.

FIG. 17 is a diagram showing a circuit layout for explaining a position of a through-hole in the display device of the embodiment.

FIG. 18 is a first cross-sectional view (A-A) of the circuit in FIG. 17.

FIG. 19 is a second cross-sectional view (B-B) of the circuit in FIG. 17.

### DETAILED DESCRIPTION

In general, according to one embodiment, a liquid crystal display device includes a liquid crystal panel and a controller. The liquid crystal panel includes a pixel and a polarity signal output circuit. The pixel includes a pixel memory. The polarity signal output circuit is controlled by a polarity control signal and supplies a polarity signal to the pixel. The controller supplies a video signal and the polarity control signal to the liquid crystal panel. The liquid crystal panel includes a first mode and a second mode. The first mode displays video using the video signal continuously supplied from the controller. The second mode displays video using the video signal recorded in the pixel memory. The controller includes a video signal control circuit and a microcomputer. The video signal control circuit outputs the video signal. The microcomputer controls the video signal control circuit. In the first mode, the video signal control circuit outputs the polarity control signal. In the second mode, the microcomputer outputs the polarity control signal.

Embodiments will be described hereinafter with reference to the accompanying drawings.

The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, for those elements the same as or similar to each other, which are arranged sequentially, reference symbols may be omitted. Further, the elements the same as those described in connection with preceding drawings or those exhibiting similar functions are denoted by like reference numerals, and a detailed description thereof is omitted unless otherwise necessary.

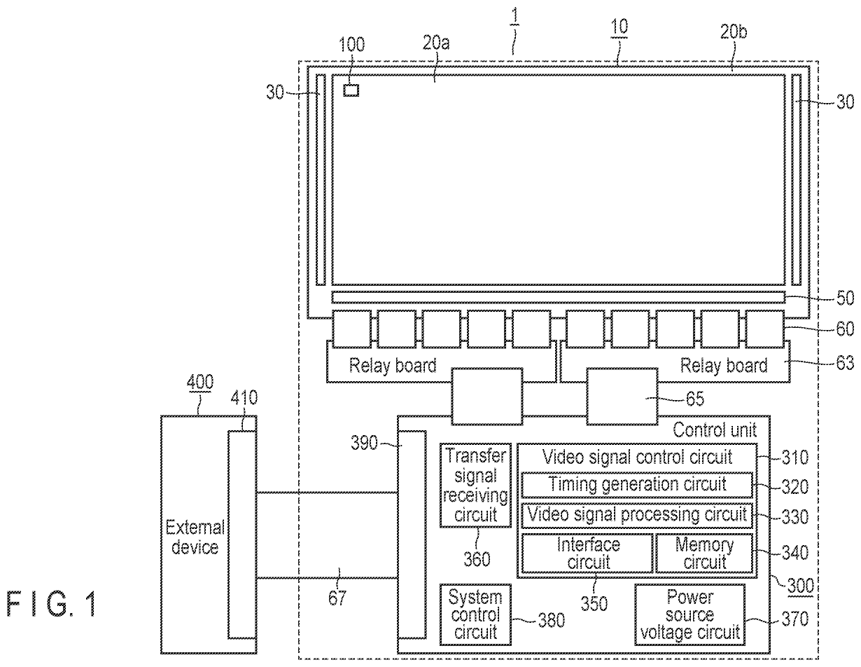

FIG. 1 is an overall view of a system of a display device 1 of the present embodiment.

The display device 1 comprises a liquid crystal display panel 10 and a control unit 300 that controls and drives the liquid crystal display panel 10.

The liquid crystal display panel 10 comprises a display area 20a that displays an image and a frame-shaped non-display area (an area located in the periphery of the display area 20a) 20b that surrounds the display area 20a. In the display area 20a of the liquid crystal display panel 10, a plurality of pixels 100 are arranged, for example, in a matrix. Each of the plurality of pixels 100 includes a switching element. A thin film transistor (TFT) is used as the switching element. As will be described in detail later, each of the plurality of pixels 100 has a configuration in which a memory-in-pixel (MIP) method including a memory circuit capable of storing video signals (data signals) is employed, and is provided with, for example, a reflective electrode in addition to the memory circuit. The display device 1 is referred to as a reflective memory built-in display device, and is known to be a display device with excellent power consumption because it does not require a backlight, and still images, etc., are displayed using data stored in the memory circuit.

Symbol 30 is a scanning signal output unit, which is electrically connected to a gate electrode of the switching element included in each of the plurality of pixels 100 via a scanning line. The scanning signal output unit 30 outputs a scanning signal that controls writing of video signals to the pixels 100. Symbol 50 is a video signal output unit, which is electrically connected to a source electrode of the switching element included in each of the plurality of pixels 100 via a video signal line. The video signal output unit 50 outputs video signals and display control signals to the display area 20a. A drain electrode of the switching element included in each of the plurality of pixels 100 is electrically connected to a memory circuit described later.

Symbol 60 is a flexible printed circuit (also referred to as FPC) which connects a relay board 63 to the liquid crystal display panel 10. The relay board 63 is divided into two pieces, one on the left and the other on the right, and supplies signals/power source voltages, etc., transmitted from the control unit 300 via a flexible printed circuit 65 to the liquid crystal display panel 10.

The control unit 300 processes signals transmitted from an external device 400 to conform to the liquid crystal display panel 10, and supplies video signals and timing signals to the liquid crystal display panel.

The control unit 300 includes a video signal control circuit 310, a transfer signal receiving circuit 360, a power source voltage circuit 370, and a system control circuit 380. The video signal control circuit 310 includes a timing generation circuit 320, a video signal processing circuit 330, a memory circuit 340, and an interface circuit 350.

A power source voltage, video signal, and control signal are supplied from the external device 400 via a cable 67. The cable 67 is connected to the external device 400 by a connector 410 and to the control unit 300 by a connector 390.

A general video signal transmitted from the external device 400 corresponds to a pixel configured by sub-pixels of three colors of red, green, and blue, and the gradation of each color is expressed by digital data of 6 bits or more. In contrast, in the display device 1 of the present embodiment, which is a reflective memory built-in display device, the sub-pixels are n colors, which are three or more colors, and the number of bits to express the gradation is m bits, which is 6 bits or less.

Accordingly, the control unit 300 processes general video signals, power source voltages, and control signals transmitted from outside to be formed as video signals, power source voltages, and control signals corresponding to the display device 1 of the present embodiment, which is a reflective memory built-in display device, and supplies them to the liquid crystal display panel 10.

Although the description herein is based on a case where the sub-pixels have four colors and the number of bits to express gradation is 3 bits, the case is not limited thereto.

The video signal control circuit 310 converts the video signals transmitted from the outside into video signals compatible with the reflective memory built-in display device, and also forms timing signals necessary for display and supplies them to the liquid crystal display panel 10.

The transfer signal receiving circuit 360 receives video signals transmitted from the outside that are in accordance with standards such as LVDS, which is used for short-range high-speed transmission.

The power source voltage circuit 370 generates a voltage required for the reflective memory built-in display device from a power source voltage of, for example, 12 V DC, which is transmitted from the outside.

The system control circuit 380 controls the transfer signal receiving circuit 360 to receive video signals from the outside, controls the video signal control circuit 310 to convert the video signals received by the transfer signal receiving circuit 360, controls the power source voltage circuit 370 to generate and supply the voltage required for the reflective memory built-in display device, and inputs and outputs control signals to and from the external device 400 via the connector 390.

In addition to performing the general control of the control unit 300 in the manner described above, the feature of the system control circuit 380 is also to supply a timing signal required for display (details to follow) to the liquid crystal display panel 10. The system control circuit 380 can use, for example, a micro control unit (MCU), and includes an input/output unit in addition to the CPU and a memory storing a program. The system control circuit 380 can supply the timing signal necessary for display to the liquid crystal display panel 10 using the input/output unit.

The display device 1 of the present embodiment is a reflective memory built-in display device in which the pixels 100 include reflective electrodes and memory circuits as described above, and includes a drive mode (hereinafter also referred to as a controller mode) in which the video signal control circuit 310 uses signals from a controller that outputs signals necessary for display, and a drive mode (hereinafter also referred to as a memory mode) in which signals recorded in the memory circuit are used. The controller mode is a drive mode suitable for application when displaying moving images, and the memory mode is a drive mode suitable for application when displaying still images.

In the controller mode, the control unit 300 performs input and output of control signals to and from the system control circuit 380 by the interface circuit 350, stores control signals and video signals in the memory circuit 340, converts video signals to become compatible with the reflective memory built-in display device in the video signal processing circuit 330, and forms timing signals necessary for display in the timing generation circuit 320.

Furthermore, the control unit 300 supplies video signals, power source voltages, and control signals by dividing them to the left and right sides of the liquid crystal display panel 10. The relay board 63 is divided into two pieces, one for the left side and the other for the right side of the liquid crystal display panel 10. Five flexible printed circuits 60 are connected from each relay board 63 to the liquid crystal display panel 10. The signals necessary for display are supplied to the liquid crystal display panel 10 via the flexible printed circuits 60.

In the memory mode, the control unit 300 stops the operation of the video signal processing circuit 330, etc., and outputs timing signals required in the memory mode from the system control circuit 380 to the liquid crystal display panel 10.

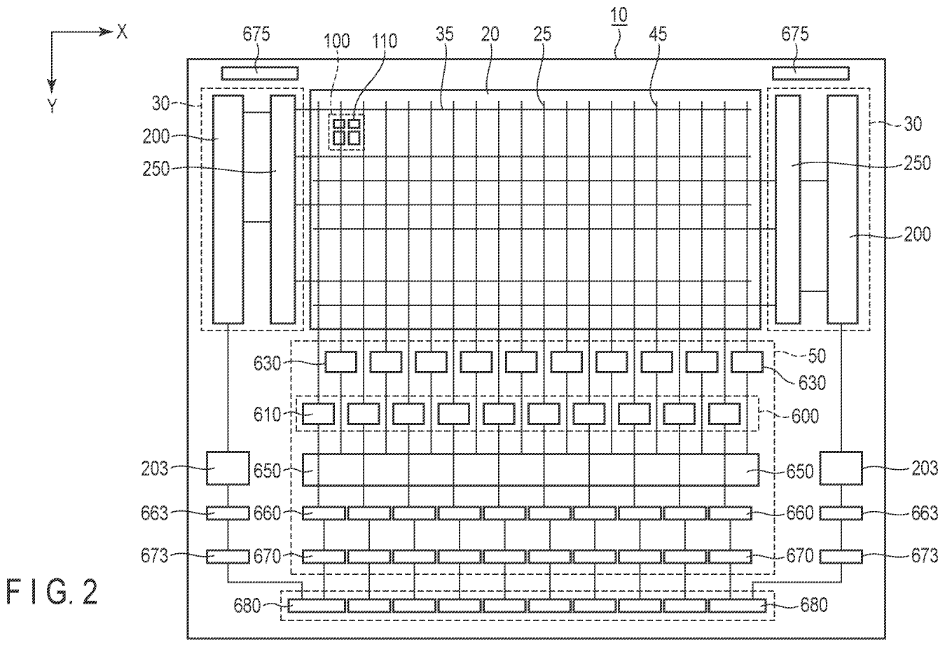

FIG. 2 is a block diagram of the liquid crystal display panel 10. As mentioned above, the pixels 100 are arranged in a matrix in the display area 20a. However, in the drawing, only one pixel 100 is described for simplicity.

A plurality of pixels 100 are arranged in a matrix in an X-Y plane defined by a first direction X and a second direction Y. For example, in a case where the resolution of the liquid crystal display panel 10 is 1920×1080, 1920 pixels 100 are arranged side by side in the first direction X, and 1080 pixels 100 are arranged side by side in the second direction Y.

The pixel 100 is the smallest unit of configuring a color image. The pixel 100 comprises a plurality of sub-pixels 110. FIG. 2 illustrates a case in which the pixel 100 is provided with four sub-pixels 110 arranged two by two in the first direction X and the second direction Y.

A plurality of scanning lines 35 are connected to the scanning signal output unit 30 so that they are arranged side by side in the second direction Y. Two scanning signal output units 30 are formed in the non-display area 20b and are arranged facing each other with the display area 20a in between. In this case, odd-numbered rows of scanning lines 35 are connected to one of the scanning signal output circuits 30, and even-numbered rows of scanning lines 35 are connected to the other scanning signal output circuit 30. In other words, the plurality of scanning lines 35 are connected to the two scanning signal output units 30 alternately.

The scanning signal output units 30 are formed on the left and right sides of the display area 20a. The scanning signal output unit 30 includes a scanning shift register 200 and a buffer circuit 250.

The buffer circuit 250 outputs scanning signals to the scanning lines 35 in accordance with timing signals output from the scanning shift register 200. The scanning signals are output to the scanning lines 35 in order from top to bottom or from bottom to top in the drawing.

The same number of scanning lines 35 as the number of sub-pixels 110 arranged in the second direction Y are connected to the scanning signal output unit 30. As described above, since it is assumed here that the pixel 100 comprises four sub-pixels 110 arranged two by two in the first direction X and the second direction Y, the number of sub-pixels 110 arranged in the second direction Y is two. Therefore, in the case where the resolution of the liquid crystal display panel 10 is 1920×1080 as described above, the number of scanning lines 35 connected to the scanning signal output unit 30 in the liquid crystal display panel 10 is 2×1080=2160.

As will be described in detail later, the switching elements provided in the sub-pixels 110 are controlled by two signals whose polarities are inverted from each other. For this reason, each of the scanning lines 35 shown in FIG. 2 is actually configured by two signal lines for outputting these two signals. Both of these two signal lines extend in the first direction X and are arranged side by side in the second direction Y.

A plurality of video signal lines 25 are connected to the video signal output unit 50 in a manner arranged side by side in the first direction X intersecting the second direction Y. The video signal output unit 50 is formed at the lower part of the non-display area 20b in the drawing.

The video signal output unit 50 includes a video signal output circuit 600, a polarity signal output circuit 630, a polarity signal shift register 650, a level shifter 660, and an electrostatic breakdown prevention circuit 670.

The video signal output circuit 600 outputs video signals to the video signal line 25. The polarity signal output circuit 630 outputs polarity signals to a polarity signal line 45. The polarity signal shift register 650 outputs a timing signal that indicates a timing for the polarity signal output circuit 630 to output the polarity signals. The level shifter 660 converts the video signals into a voltage/current that can be driven by the video signal output circuit 600. The electrostatic breakdown prevention circuit 670 is a protection circuit provided for an input terminal 680 to prevent electrostatic breakdown.

The video signal output unit 50 is connected to a number of video signal lines 25 corresponding to the number of sub-pixels 110 arranged in the first direction X and the number of bits expressing the gradation of each color. Here, since it is assumed that the pixel 100 comprises four sub-pixels 110 arranged two by two in the first direction X and the second direction Y, the number of sub-pixels 110 arranged in the first direction X in one pixel 100 is two. In addition, since it is assumed here that the number of bits to express gradation for each color is 3 bits, the number of video signal lines 25 required for one sub-pixel 110 is three. In other words, the number of video signal lines 25 required for two sub-pixels 110 that are placed adjacent to each other in the first direction X in one pixel 100 is 2×3=6.

According to the above, in the case where the resolution of the liquid crystal display panel 10 is 1920×1080 as described above, the number of video signal lines 25 connected to the video signal output unit 50 in the liquid crystal display panel 10 is 6×1920=11520.

In addition, the sub-pixels 110 adjacent in the second direction Y in one pixel 100 share the video signal lines 25.

In the case of the liquid crystal display panel 10 shown in FIG. 2, the video signals to be output to the 11520 video signal lines 25 are transferred in serial data to the video signal output circuit 600, and the video signal output circuit 600 latches the serial data transmitted from the video signal control circuit 310 and outputs it to the video signal lines 25.

In the liquid crystal display panel 10, there is a latch circuit unit for each 8-pixel column, and video signals are transmitted serially from the video signal control circuit 310 for each of the 48 (8 pixels×2 sub-pixel rows×3 bits) video signal lines 25.

The video signal output circuit 600 in FIG. 2 comprises 24 latch circuit units forming one block 610, and includes 10 blocks 610. Therefore, the video signal output circuit 600 comprises 48 lines×24 units×10 blocks, or 11520 outputs.

The polarity signal output circuit 630 outputs a polarity signal. The polarity signal is a signal to prevent degradation caused by the application of a DC voltage to the liquid crystal composition. A voltage whose polarity is inverted with respect to a reference voltage at a certain cycle is supplied to the pixel 100 as a polarity signal.

The polarity signal shift register 650 outputs a timing signal to the polarity signal output circuit 630 so that the polarity signals are not output all at once, but are output in sequence.

Symbol 203 is a scanning timing signal generator that generates a timing signal for the scanning signal output unit 30. Symbol 663 is a level shifter for the scanning timing signal generator, symbol 673 is an electrostatic breakdown prevention circuit for the scanning timing signal generator, and symbol 675 is an electrostatic breakdown prevention circuit for the scanning signal output section 30.

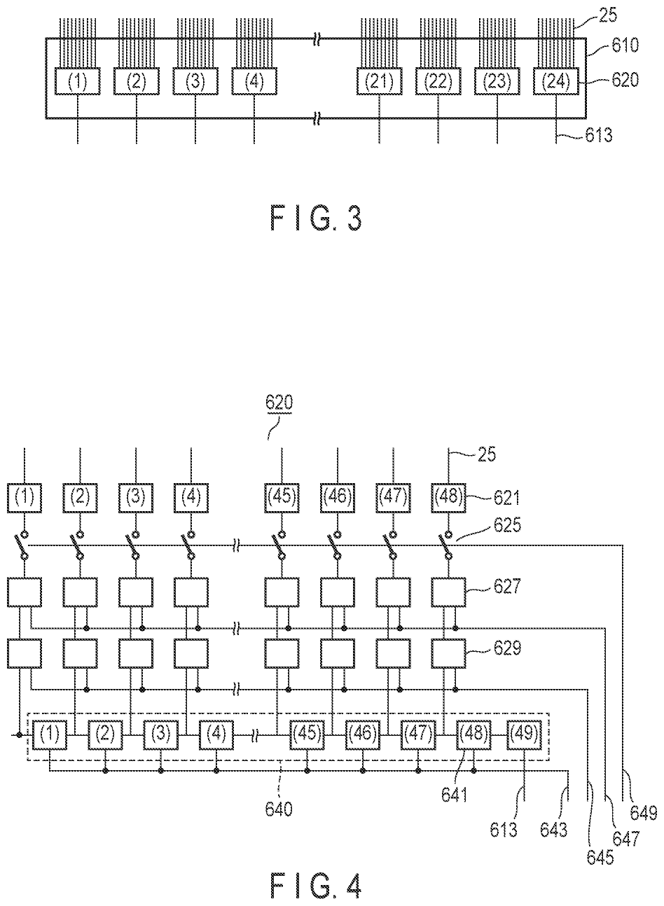

As described above, the video signal output circuit 600 comprises a plurality of blocks 610, and each block 610 comprises a plurality of latch circuit units 620 (see FIG. 3). Although the description herein is based on the case where there are 10 blocks 610 and 24 latch circuit units 620, these numbers can be selected arbitrarily depending on the number of video signal lines 25, etc.

FIG. 3 shows the block 610, which comprises 24 latch circuit units 620. Each latch circuit unit 620 outputs a video signal to 48 video signal lines 25. For the input, there is one input line 613 since the video signal is transmitted from the video signal control circuit 310 in the serial data.

FIG. 4 shows the latch circuit unit 620, where the input line 613 is input to a shift register circuit 640 in which 49 latch circuits 641 are connected in series. The video signals input to the 49th latch circuit 641 are transferred in order in synchronization with a transfer clock supplied by a transfer clock line 643, and when 48 video signals are held in the latch circuit 641, they are simultaneously transferred from the shift register circuit 640 to a first-stage latch circuit 629 by a first read signal supplied by a first read (load) signal line 645.

When the video signals are continuously transferred from the video signal control circuit 310, and 48 video signals are held in the latch circuit 641 again, they are simultaneously transferred from the shift register circuit 640 to the first-stage latch circuit 629 by the first read signal supplied by the first read (load) signal line 645.

Before the video signals are transferred from the shift register circuit 640 to the first-stage latch circuit 629 for the second time, the 48 video signals transferred the first time are transferred from the first-stage latch circuit 629 to a second-stage latch circuit 627 by a second read signal supplied by a second read (load) signal line 647.

After the video signals are prepared in the first-stage latch circuit 629 and the second-stage latch circuit 627, a switch circuit 625 to which a write signal is supplied by a write signal line 649 becomes conductive, and the video signals are transferred to a buffer circuit 621 which, then, writes the video signals on the video signal line 25.

In general display devices, a video signal written on a video signal line is a so-called analog signal with a voltage corresponding to the gradation to be displayed, while the video signal written on the video signal line 25 is a so-called digital signal with a binary voltage. However, one of the binary voltages written on the video signal line 25 is a voltage capable of driving liquid crystal molecules in the pixel 100 or a voltage close to the voltage capable of driving the liquid crystal molecules.

In other words, a voltage of about 10 V is used to drive the liquid crystal molecules, and the video signals supplied to the pixel 100 are held in the memory circuit in the pixel 100. However, since there is no room for a level shifter in the pixel 100, the voltage to be supplied to the pixel 100 is a voltage that can drive the liquid crystal molecules or a voltage close to the voltage that can drive the liquid crystal molecules.

As shown in FIG. 5, the buffer circuit 621 includes a level shifter circuit 622 and an output inverter circuit 623. The video signals transmitted from the second-stage latch circuit 627 are boosted by the level shifter circuit 622 to a voltage that can drive the output inverter circuit 623. Symbol VSH is a power source voltage line on a high voltage side of the buffer circuit 621, and VSS is a power source voltage line on a low voltage side thereof.

The output inverter circuit 623 is configured by a plurality of inverter circuits comprising a voltage capable of driving the liquid crystal molecules as the power source voltage. Transistors configuring the output inverter circuit 623 are of a size in which the load of the video signal line 25 can be sufficiently driven. Therefore, for example, the channel width is 300 μm or more, and the power source voltage configuring the latch circuit unit 620 is 70 times or more than that of the transistors of the 5 V system.

Therefore, the through voltage flowing to the output inverter circuit 623 at the moment the switch circuit 625 becomes conductive is very large and becomes a load on the power source voltage circuit 370.

The video signal output circuit 600 distributes the load on the power source voltage circuit 370 by shifting the timing at which the switch circuit 625 becomes conductive. Specifically, there are 240 units of latch circuit units 620 (24 units×10 blocks); however, the liquid crystal display panel 10 is divided into two parts, one on the left and the other on the right, and power source voltages of two systems are supplied via the relay boards 63, thereby shifting the output timings of the 120 latch circuit units 620 on the left and the right.

The video signal control circuit 310 creates a write signal with the timing shifted for each latch circuit unit 620 and outputs it to the write signal line 649.

The polarity signal output circuit 630 also comprises the same problem of prominently increasing the load on the power source voltage circuit 370. The polarity signal shifts the output timing by using the polarity signal shift register 650.

In order to support the aforementioned memory mode, the liquid crystal display panel 10 incorporates the polarity signal output circuit 630 and the polarity signal shift register 650 to enable the output of polarity signals internally.

The polarity signal shift register 650 supplies timing signals to the polarity signal output circuit 630 in sequence, and the polarity signal output circuit 630 outputs polarity signals in sequence at regular intervals. The polarity signal shift register 650 is formed in 240 stages, for example, and the polarity signals are output from 240 polarity signal output circuits 630.

In a case where the polarity signals are output simultaneously from all the polarity signal output circuits 630 provided in the liquid crystal display panel 10, there is a problem that a large load will be applied to the power source voltage circuit 370, as in the case of the video signal output circuit 600 described above. For this reason, the polarity signal shift register 650 outputs timing signals to shift the timing at which the polarity signals are output by each polarity signal output circuit 630, and distributes and reduces the load on the power source voltage circuit 370. For example, as a specific configuration, the polarity signal shift register 650 is formed in the same number of stages as the polarity signal output circuits 630, and by outputting timing signals to the polarity signal output circuits 630 corresponding to each stage in sequence, the timing of outputting the polarity signals by the polarity signal output circuits 630 is shifted.

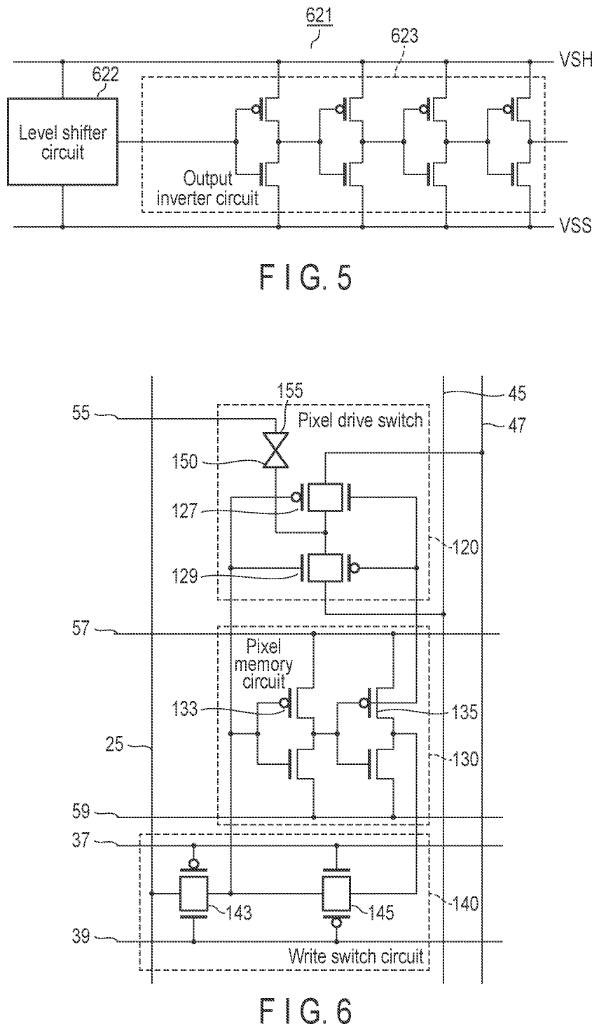

FIG. 6 shows a pixel circuit. Symbol 120 is a pixel drive switch circuit, symbol 130 is a pixel memory circuit, and symbol 140 is a write switch circuit.

Symbols 37 and 39 are write control signal lines, symbol 45 is the polarity signal line, symbol 47 is a reference voltage line, symbol 55 is a common signal line, and symbols 57 and 59 are memory power lines.

The pixel memory circuit 130 is formed by connecting inverter circuits 133 and 135 in series, and the output of the inverter circuit 135 is connected to the input of the inverter circuit 133 via a transfer gate 145 of the write switch circuit 140.

The pixel memory circuit 130 with the above structure records input digital data (binary value of logic value “1” or “0”) for one bit. Therefore, digital data is supplied from the video signal line 25. When a transfer gate 143 becomes conductive by the write control signal lines 37 and 39, digital data is input to the pixel memory circuit 130, and when the transfer gate 143 becomes non-conductive and the transfer gate 145 becomes conductive, digital data is recorded in the pixel memory circuit 130.

In a case where the output of the inverter circuit 133 of the pixel memory circuit 130 is “0” (low voltage supplied to the pixel memory circuit 130 by the memory power line 50), a transfer gate 129 of the pixel drive switch circuit 120 becomes conductive, and the polarity signal supplied via the polarity signal line 45 is supplied to a pixel electrode 150. In a case where the output of the inverter circuit 133 is “1” (high voltage supplied to the pixel memory circuit 130 by the memory power line 50), a transfer gate 127 becomes conductive, and a reference signal supplied via the reference voltage line 47 is supplied to the pixel electrode 150.

A common electrode 155 is formed opposite to the pixel electrode 150, and a liquid crystal composition is disposed between the pixel electrode 150 and the common electrode 155. Display is performed by changing the alignment direction of the liquid crystal molecules due to the potential difference between the pixel electrode 150 and the common electrode 155.

For example, the display becomes black (small amount of transmitted light) in a case where a potential difference is created between the pixel electrode 150 and the common electrode 155, the liquid crystal molecules are aligned along an electric line of force between the pixel electrode 150 and the common electrode 155, and polarization directions of two polarizing elements sandwiching a liquid crystal composition intersect without changing the polarization directions of light passing through the liquid crystal composition. Furthermore, the display becomes white (large amount of transmitted light) in a case where the liquid crystal molecules are twisted and aligned, and the polarization direction of the light passing through the liquid crystal composition is rotated by 90 degrees without creating a potential difference between the pixel electrode 150 and the common electrode 155.

In the present embodiment, the potential difference between the pixel electrode 150 and the common electrode 155 is about 5 V, and the polarity of the voltage applied to the pixel electrode 150 is inverted at a certain cycle in order to prevent a DC voltage from being continuously applied to the liquid crystal element composition.

As an example, a voltage applied to the common electrode 155 can be set to 5 V, and a polarity signal applied to the pixel electrode 150 can be set to 0 V and 10 V. In this case, in order to make the transfer gates 127 and 129 of the pixel drive switch circuit 120 conductive, the power source voltage of the pixel memory circuit 130 is supplied with a voltage of approximately 10 V on the memory power line 57 and approximately 0 V on the memory power line 59.

The high voltage of the digital data supplied from the video signal line 25 is approximately 10 V, and the low voltage is approximately 0 V.

Therefore, the power source voltage of the output inverter circuit 623 described above is also approximately 10 V for VSH and approximately 0 V for VSS.

The display device 1 is a reflective memory built-in display device and has a display mode in which the supply of digital data supplied from the video signal line 25 is stopped, and the data recorded in the pixel memory circuit 130 is used for display, in which case the control unit 300 shown in FIG. 1 stops outputting digital data to the video signal line 25 and maintains the output of the polarity signal.

The control unit 300 not only stops the output to the video signal line 25, but also stops the generation of the digital data to be output to the video signal line 25. The reflective memory built-in display device of the present invention comprises sub-pixels 110 of four colors as described above, and each sub-pixel 110 displays 3 bits of data in area gradation as described later. Since general display devices comprise sub-pixels of three colors, and displays the gradation using digital data of about 6 to 24 bits for each color, the control unit 300 converts digital data of 3 bits or more into digital data of 3 bits and generates data for four colors from the data of three colors.

Therefore, in the case of stopping the supply of digital data, the control unit 300 stops the video signal control circuit 310. However, since the video signal control circuit 310 includes the timing generation circuit 320, when the video signal control circuit 310 is stopped, the output of the polarity signal is also stopped.

Since power consumption cannot be reduced if the operation of the video signal control circuit 310 continues to be maintained for the output of the polarity signal, the system control circuit 380 in the control unit 300 is used to output a signal to control the polarity signal.

The system control circuit 380 is configured by a micro control unit (MCU) including an output circuit and outputs a signal that controls the polarity signal output circuit 630 and the polarity signal shift register 650 by controlling the output circuit.

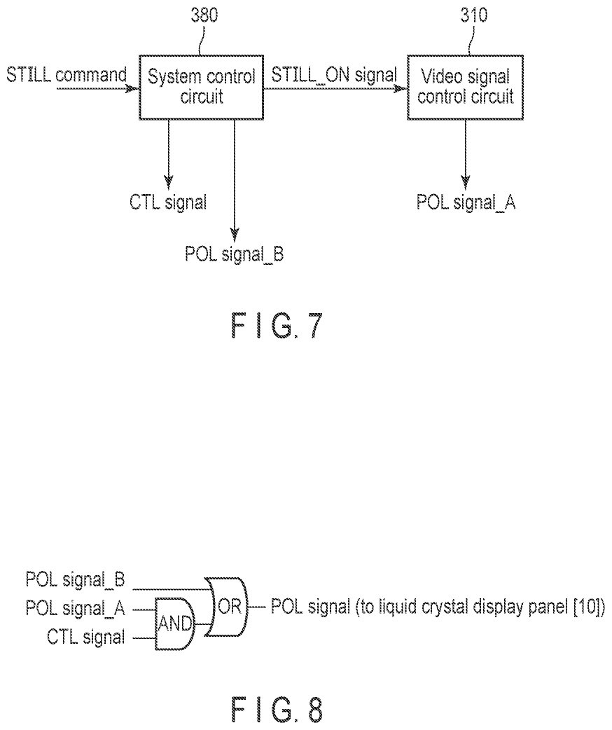

Here, with reference to FIGS. 7 to 9, explanations will be provided on the display unit 1 of the present embodiment equipped with a mechanism for outputting signals to control the polarity signal using the system control circuit 380, thereby enabling the video signal control circuit 310 to be stopped when it is in the memory mode.

FIG. 7 is a diagram showing the linkage between the system control circuit 380 and the video signal control circuit 310 relating to the output of polarity signals.

Here, it is assumed that a command requesting a switch between the controller mode and the memory mode is transmitted as one of the control signals transmitted from the outside. As mentioned above, the controller mode is a drive mode suitable for application when displaying moving images, and the memory mode is a drive mode suitable for application when displaying still images. In FIG. 7, a STILL command indicates a command transmitted from the outside for requesting switching from the controller mode to the memory mode.

As mentioned above, the video signal control circuit 310 outputs signals for controlling the polarity signals, more specifically, timing signals. In FIG. 7, a POL signal_A indicates a timing signal output by the video signal control circuit 310. When in the controller mode, the POL signal_A is output from the video signal control circuit 310. Furthermore, when in the controller mode, a CTL signal is output from the system control circuit 380. The role of the CTL signal will be explained later; however, the CTL signal is used to invalidate the POL signal_A that is erroneously output from the video signal control circuit 310 when switching between controller mode and memory mode. The CTL signal and the POL signal_A are output in synchronization.

When in the controller mode where the POL signal_A and the CTL signal are output, if the STILL command is transmitted from the outside, the system control circuit 380 starts outputting a signal for controlling the polarity signal, more specifically, a timing signal, and stops outputting the CTL signal. In FIG. 7, a POL signal_B indicates a timing signal output by the system control circuit 380. The system control circuit 380 also instructs the video signal control circuit 310 to stop outputting the POL signal_A. In FIG. 7, a STILL_ON signal is a signal transmitted by the system control circuit 380 to the video signal control circuit 310 for instructing to stop outputting the POL signal_A.

The transmission of the STILL_ON signal by the system control circuit 380 to the video signal control circuit 310 occurs at the same time as or after starting the output of the POL signal_B and stopping the output of the CTL signal by the system control circuit 380, and at least not prior to this. When the STILL_ON signal is received, the video signal control circuit 310 stops the output of the POL signal_A. In other words, in the memory mode, only the POL signal_B is output.

When in the memory mode where only the POL signal_B is output, if a command requesting a switch from the memory mode to the controller mode is transmitted from the outside, the system control circuit 380 instructs the video signal control circuit 310 to start outputting the POL signal_A, stops outputting the POL signal_B, and starts outputting the CTL signal.

FIG. 8 is a diagram showing an example of a circuit provided in the control unit 300 for exclusively and selectively outputting one of the POL signal_A from the video signal control circuit 310 and the POL signal_B from the system control circuit 380 to the liquid crystal display panel 10.

As described above, the system control circuit 380 outputs the CTL signal when it is in the controller mode and outputs the POL signal_B when it is in the memory mode. In addition, the video signal control circuit 310, which operates under the control of the system control circuit 380, outputs the POL signal_A when it is in the controller mode. In other words, the POL signal_A is output from the video signal control circuit 310 in the controller mode, and the POL signal_B is output from the system control circuit 380 in the memory mode; therefore, basically, if the POL signal_A is output from the video signal control circuit 310, such POL signal_A should be output to the liquid crystal display panel 10, and if the POL signal_B is output from the system control circuit 380, such POL signal_B should be output to the liquid crystal display panel 10. In other words, the logical sum of POL signal_A and POL signal_B should be output.

However, when switching between the controller mode and memory mode, it is difficult to match the timing between stopping or starting the output of the POL signal_A by the video signal control circuit 310 and starting or stopping the output of the POL signal_B by the system control circuit 380. For example, if there is a time lag between the reception of the STILL_ON signal and the stopping of the output of the POL signal_A in the video signal control circuit 310, the POL signal_A may be output erroneously.

Therefore, in the display unit 1 of the present embodiment, the POL signal_A output from the video signal control circuit 310 is output to the liquid crystal display panel 10 only when the CTL signal is output from the system control circuit 380, as shown in FIG. 8. More specifically, the logical product of the POL signal_A and the CTL signal is obtained before the logical sum of the POL signal_A and the POL signal_B is obtained. In other words, the system control circuit 380 can handle the validity or invalidity of the POL signal_A output from the video signal control circuit 310. When the STILL command is received, the system control circuit 380 starts the output of the POL signal_B and stops the output of the CTL signal, thereby invalidating the POL signal_A that is erroneously output from the video signal control circuit 310 after the STILL_ON signal is transmitted to the video signal control circuit 310.

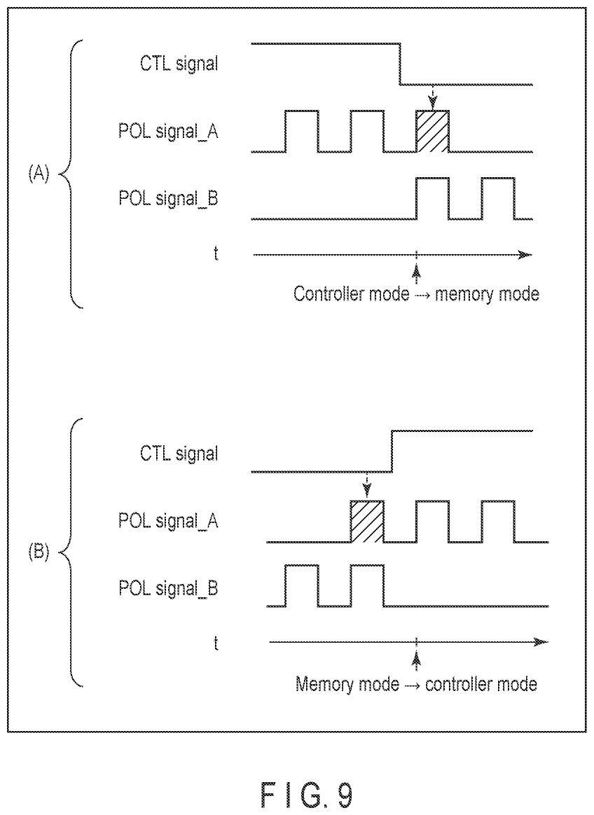

FIG. 9 is a timing chart showing the output timing of the CTL signal, POL signal_A, and POL signal_B when switching between controller mode and memory mode.

(A) shows the output timing of the CTL signal, POL signal_A, and POL signal_B when switching from the controller mode to the memory mode.

In the controller mode before switching to the memory mode, the CTL signal is output from the system control circuit 380, and the POL signal_A is output from the video signal control circuit 310. Therefore, the POL signal_A output from the video signal control circuit 310 is valid, and since the POL signal_B is not output from the system control circuit 380, the POL signal_A output from the video signal control circuit 310 is output to the liquid crystal display panel 10.

When switching from the controller mode to the memory mode, the system control circuit 380 starts outputting the POL signal_B and stops outputting the CTL signal. Therefore, even if the POL signal_A is erroneously output from the video signal control circuit 310 after the STILL_ON signal is transmitted by the system control circuit 380, the POL signal_A (the signal with a shaded hatch) is invalidated and the POL signal_B output from the system control circuit 380 is output to the liquid crystal display panel 10.

(B) shows the output timing of the CTL signal, POL signal_A, and POL signal_B when switching from the memory mode to the controller mode.

In the memory mode before switching to the controller mode, only the POL signal_B is output from the system control circuit 380. Therefore, the POL signal_B output from the system control circuit 380 is output to the liquid crystal display panel 10.

When switching from the memory mode to the controller mode, the system control circuit 380 instructs the video signal control circuit 310 to start outputting the POL signal_A, stops outputting the POL signal_B, and starts outputting the CTL signal. Since the POL signal_A output from the video signal control circuit 310 is valid when the CTL signal is output from the system control circuit 380, the system control circuit 380, for example, first instructs the video signal control circuit 310 to start outputting the POL signal_A, and then, after a margin period during which the POL signal_A is assumed as being output without fail, stops outputting the POL signal_B, and starts outputting the CTL signal, thereby enabling smooth switching from the POL signal_B to the POL signal_A. In this margin period, consequently, the POL signal_A (the signal with a shaded hatch) that is erroneously output from the video signal control circuit 310 before the switchover to the controller mode can be invalidated.

As described above, in the display unit 1 of the present embodiment, when in the memory mode, the video signal control circuit 310 can be stopped by a mechanism that uses the system control circuit 380 to output a signal for controlling the polarity signal. In other words, a liquid crystal display device excelling further in saving power consumption can be realized.

The power source voltage circuit 370 of the control section 300 includes a circuit for generating power for operation of the video signal output unit of the liquid crystal display panel 10 and a circuit for generating power for operation of the video signal control circuit 310 in the control unit 300. The system control circuit 380 deactivates these circuits when switching from the controller mode to the memory mode. Needless to say, when switching from the memory mode to the controller mode, the system control circuit 380 activates the deactivated circuits.

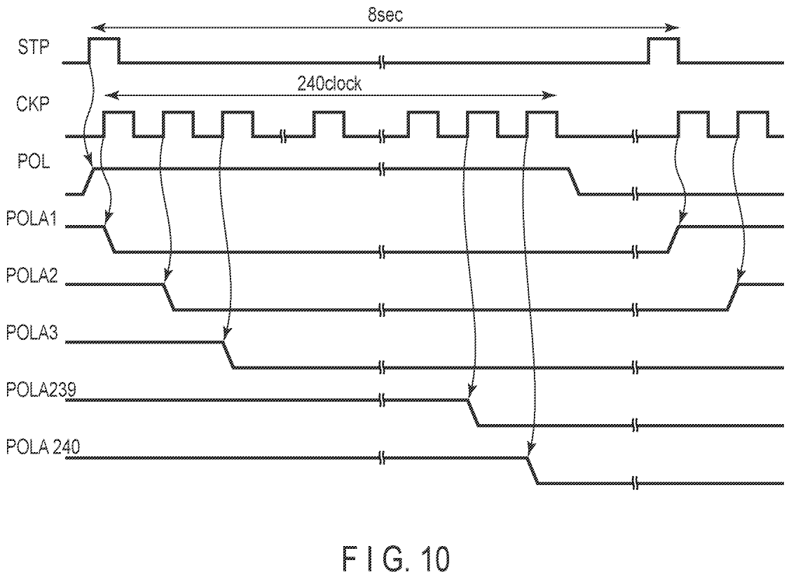

FIG. 10 shows signals output by the system control circuit 380 for controlling the polarity signal shift register 650 and the output of the polarity signal output circuit 630 in the memory mode. In the controller mode, the signals for controlling the polarity signal shift register 650 is output by the video signal control circuit 310.

Symbol STP is a start signal, CKP is a clock signal, and POL is a polarity signal. The polarity signal POL is output in accordance with the start of outputting the start signal STP. The polarity signal shift register 650 outputs a timing signal for controlling the polarity signal output circuit 630 in accordance with the clock signal CKP.

Symbol POLA1 indicates the output of the first polarity signal output circuit 630, and for example, indicates the output of the leftmost polarity signal output circuit 630 in FIG. 2. The polarity signal shift register 650 outputs the timing signals of the second and third polarity signal output circuits 630 in sequence, up to the timing signal of the 240th polarity signal output circuit 630.

The output interval of the start signal STP can be set arbitrarily. Therefore, for example, the start signal STP is output with an interval of eight seconds after the clock signal CKP is output 240 times. The output POLAn of the arbitrary polarity signal output circuit 630 maintains the output in accordance with the value of the polarity signal POL at the time of receiving the timing signal from the polarity signal shift register 650. By a timing signal received eight seconds later from the polarity signal shift register 650, the output is switched to an output in accordance with the value of the polarity signal POL at that time.

Therefore, the output of the polarity signal output circuit 630 is not only switched by the timing signal from the polarity signal shift register 650, but also needs to be maintained until the next timing signal.

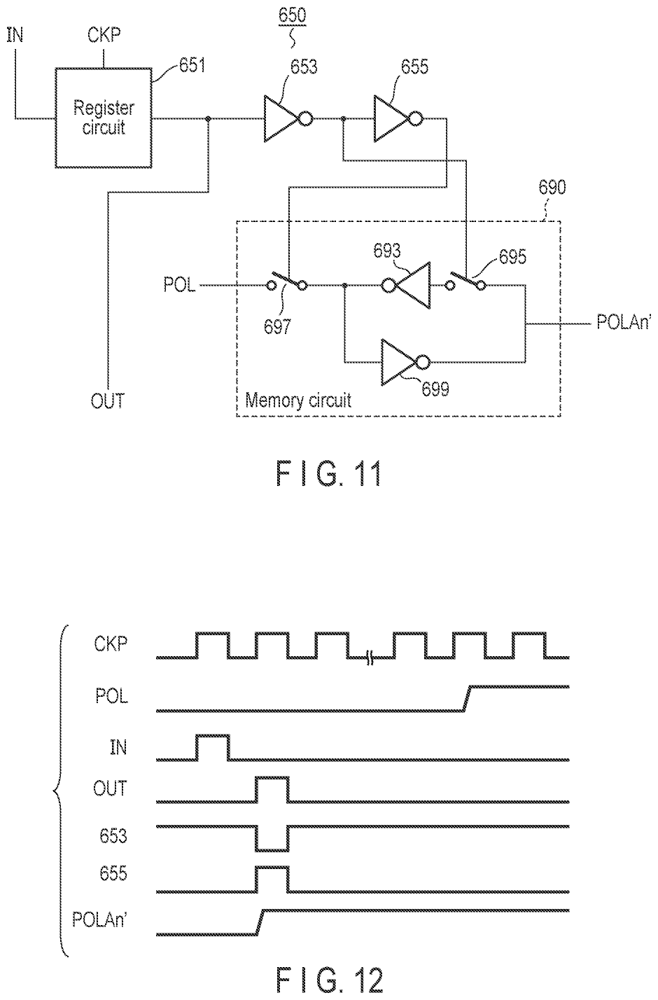

FIG. 11 shows a circuit in which the output of the polarity signal output circuit 630 is switched by a timing signal from the polarity signal shift register 650, and the output is maintained until the next timing signal. FIG. 12 shows a timing chart of the circuit shown in FIG. 11.

In FIG. 11, symbol 651 indicates an nth stage register circuit of the polarity signal shift register 650 configured by a plurality of stages of register circuits. IN indicates an input signal from a previous stage, and OUT indicates the output of an nth stage register circuit 651. 690 is a memory circuit which inputs the value of the polarity signal POL to an inverter circuit 699, and outputs an output POLAn′.

Inverter circuits 699 and 693 form a memory circuit when a switching element 695 is conductive. In the case where the output OUT is a low voltage, an inverter circuit 653 outputs a high voltage, the switching element 695 becomes conductive, and the inverter circuits 699 and 693 maintain the output.

When the output OUT of the register circuit 651 becomes a high voltage, the switching element 695 becomes non-conductive, and a switching element 697 becomes conductive, so that the value of the polarity signal POL is input to the inverter circuit 699. Subsequently, when the output OUT becomes a low voltage, the polarity signal POL becomes non-conductive, the switching element 695 becomes conductive, and the inverter circuits 699 and 693 maintain the value of the polarity signal POL.

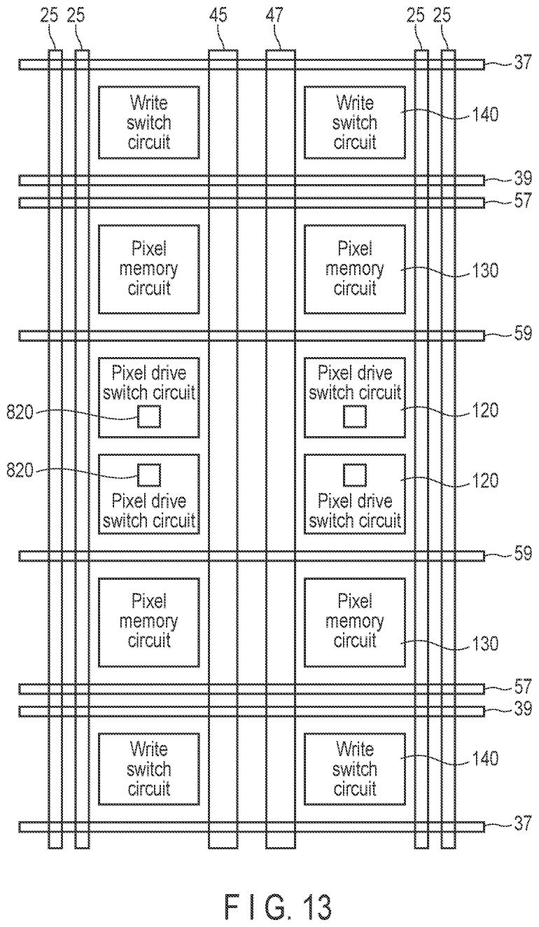

FIG. 13 shows a block diagram of a circuit in the periphery of pixels. In FIG. 13, four sub-pixels arranged side by side in two rows and two columns are shown.

The write control signal lines 37 and 39 are arranged vertically in the drawing with the write switch circuit 140 in between. In FIG. 2, the write control signal lines 37 and 39 are combined into one line and displayed as the scanning line 35.

The memory power lines 57 and 59 are also formed above and below the pixel memory circuit 130. Therefore, the memory power lines 57 and 59 are supplied from the left and right sides of the display area 20a shown in FIG. 2.

Each of the two video signal lines 25 extends in the vertical direction in the drawing, and is formed every two rows of sub-pixels.

The polarity signal line 45 and the reference voltage line 47 extend in the vertical direction of the display area 20a, and the polarity signal and reference voltage are supplied from the lower side in the drawing. The polarity signal line 45 and the reference voltage line 47 are formed thicker than the video signal line 25 in order to strengthen the voltage supply capacity.

Symbol 820 indicates the position of a through-hole connecting the pixel drive switch circuit 120 to the pixel electrode 150.

A video signal supplied via the video signal line 25 is recorded in the pixel memory circuit 130 via the write switch circuit 140 that is made conductive by the write control signal lines 37 and 39. A power source voltage is supplied to the pixel memory circuit 130 by the memory power lines 57 and 59, and the output of the pixel memory circuit 130 controls the on/off of the pixel drive switch circuit 120.

The pixel drive switch circuit 120 applies the voltage supplied by the polarity signal line 45 or the reference voltage line 47 to the pixel electrode 150 according to the output of the pixel memory circuit 130.

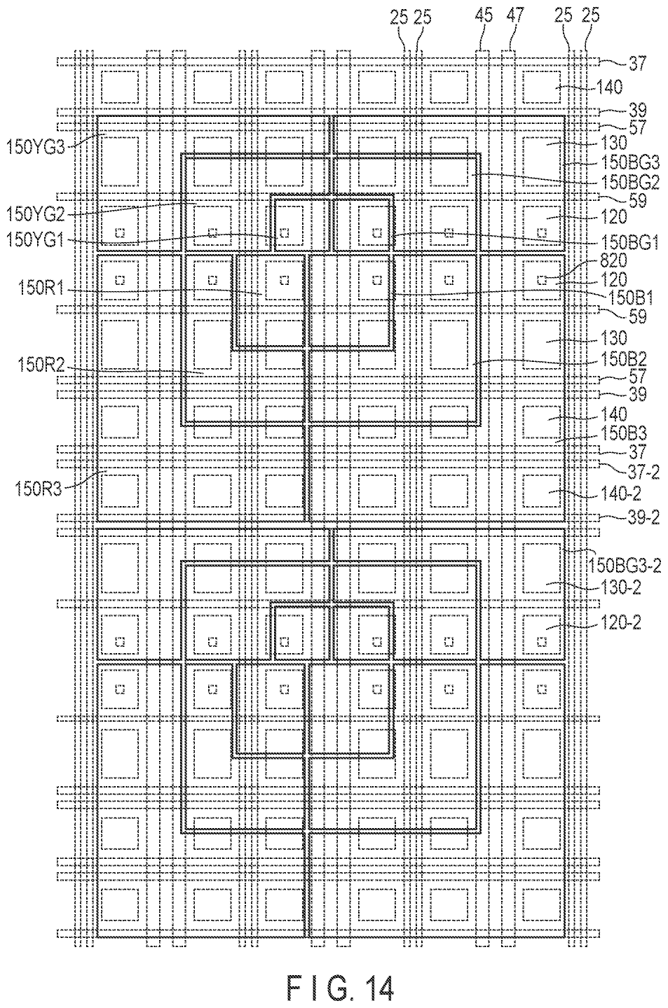

FIG. 14 shows the arrangement of the pixel electrode 150. In the drawing, two pixels are arranged vertically side by side. In one pixel, the pixel electrode 150 of a sub-pixel is formed in a manner to correspond to the four color filters. The sub-pixels of each color are formed so that the area size of the pixel electrode 150 is 1:2:4, and 3 bits of digital data is displayed using area gradation.

Symbols 150R1, 150R2, and 150R3 are pixel electrodes corresponding to a red color filter, and the pixel electrode 150R1 is where a value of a first bit of 3-bit red data (counting from the bottom) is written. In the same manner, a value of a second bit of the red data is written to the pixel electrode 150R2, and a value of a third bit of the red data is written to the pixel electrode 150R3.

Subsequently, a value of a first bit of blue data is written to a pixel electrode 150B1, a value of a second bit of blue data is written to a pixel electrode 150B2, and a value of a third bit of blue data is written to a pixel electrode 150B3.

Symbols 150YG1, 150YG2, and 150YG3 and 150BG1, 150BG2, and 150BG3 are pixel electrodes to which green data values are written. However, the pixel electrodes 150YG1 to 3 and the pixel electrodes 150BG1 to 3 correspond to color filters that transmit light of different wavelengths even in the same green bandwidth.

In the drawing, even though the size of the pixel electrodes 150 is different, the through holes 820 can be placed in positions that overlap with the pixel electrodes 150. For example, the area of the pixel electrode 150B2 is twice as large as that of the pixel electrode 150B1. The pixel electrode 150B2 is formed in a manner extending downward from the position of the through-hole 820 to overlap with the pixel memory circuit 130 that drives the pixel electrode 150B2, and then is formed in a manner extending toward a position where it overlaps with the pixel memory circuit 130 that drives the pixel electrode 150B1 (to the left in the drawing).

Furthermore, the area of the pixel electrode 150B3 is four times as large as that of the pixel electrode 150B1. The pixel electrode 150B3 is formed in a manner extending downward from the position of the through-hole 820 to overlap with the pixel memory circuit 130 and the write switch circuit 140 that drive the pixel electrode 150B3s, and then is formed in a manner extending (to the left in the drawing) from a write switch circuit 140-2 that drives the pixel electrode 150BG3 of a neighboring pixel (on the lower side in the drawing) to overlap with the write switch circuit 140-2 that drives the pixel electrode 150BG1.

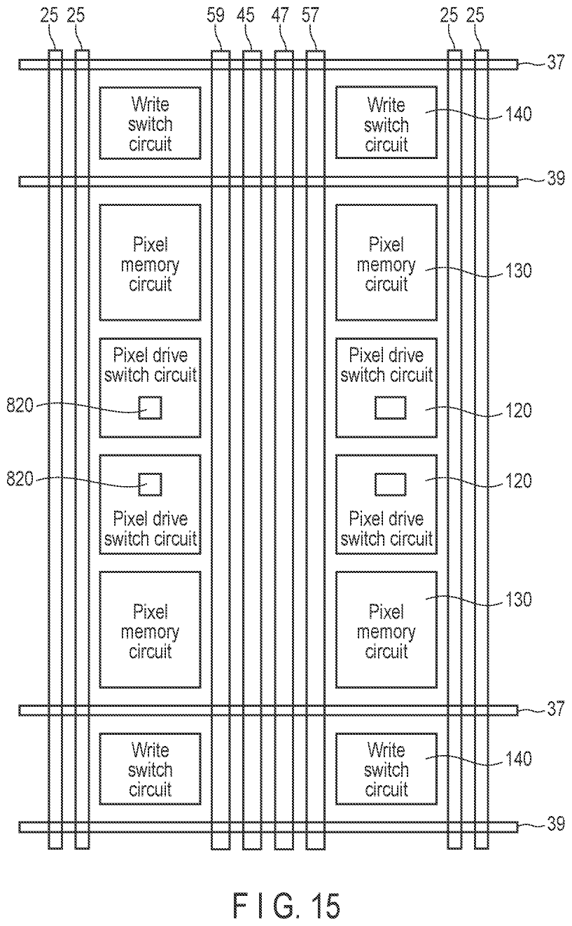

FIG. 15 shows a configuration in which the memory power lines 57 and 59 are arranged to extend along the polarity signal line 45 and the reference voltage line 47 in a vertical direction in the drawing.

In the configuration shown in FIG. 13, the memory power lines 57 and 59 intersect the video signal line 25, and a coupling capacitance is formed between them and the video signal line 25. Therefore, there was a problem that when the voltage of the video signal line 25 amplitudes, for example, 10 V on a high voltage side and 0 V on a constant voltage side, the potential of the memory power lines 57 and 59 fluctuates.

When the potential of the memory power lines 57 and 59 fluctuates, the voltage that turns the pixel drive switch circuit 120 on and off fluctuates, and for example, the transfer gates 127 and 129 will be turned on at the same time, which may cause a short circuit between the polarity signal line 45 and the reference voltage line 47, resulting in a defective display.

Therefore, in order to prevent the memory power lines 57 and 59 from intersecting with the video signal line 25, the memory power lines 57 and 59 are arranged to extend in the vertical direction as shown in FIG. 15.

In the case where the memory power lines 57 and 59 are arranged in a manner extending in the vertical direction in the drawing, it is possible to form the memory power lines 57 and 59 in the same layer (same material) as the conductive layer that configures the video signal line 25. In the case of the configuration shown in FIG. 13, where the memory power lines 57 and 59 are formed intersecting the video signal line 25, the memory power lines 57 and 59 are formed in the conductive layer of the same layer as the write control signal lines 37 and 39. While the write control signal lines 37 and 39 are formed with relatively high-resistance high-melting-point metals such as MoW and their alloys for process reasons, the video signal line 25 is formed with low-resistance metals such as aluminum and their alloys. Therefore, the power supply capability may be enhanced by forming the memory power lines 57 and 59 with a conductive layer having lower resistance than the write control signal lines 37 and 39.

The power supply capability is also enhanced by being able to arrange the memory power lines 57 and 59 in a straight line and a short distance from the input terminal 680 formed per block.

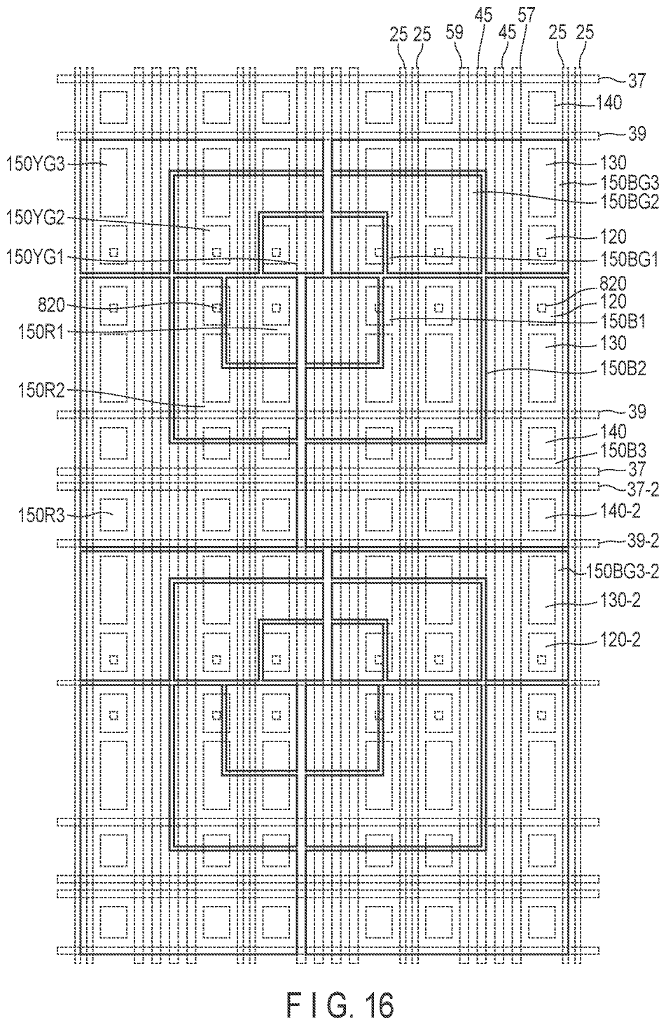

FIG. 16 shows the position of the reflective electrodes in the case of arranging the memory power lines 57 and 59 along the polarity signal line 45 and the reference voltage line 47 side by side in four lines. Two lines are added in the horizontal direction in the drawing, and the width of each circuit in the horizontal direction is narrowed. Narrowing the horizontal width in which each circuit can be formed causes a problem that the position at which the through-hole 820 connecting the pixel drive switch circuit 120 to the pixel electrode 150 is formed comes close to the edge of the pixel electrode 150.

For example, the through-hole 820 that connects the pixel electrode 150B1, where the value of the first bit of green data is written, to the pixel drive switch circuit 120 comes close to the edge of the pixel electrode 150B1. Therefore, it was necessary to move the position of the through-hole 820.

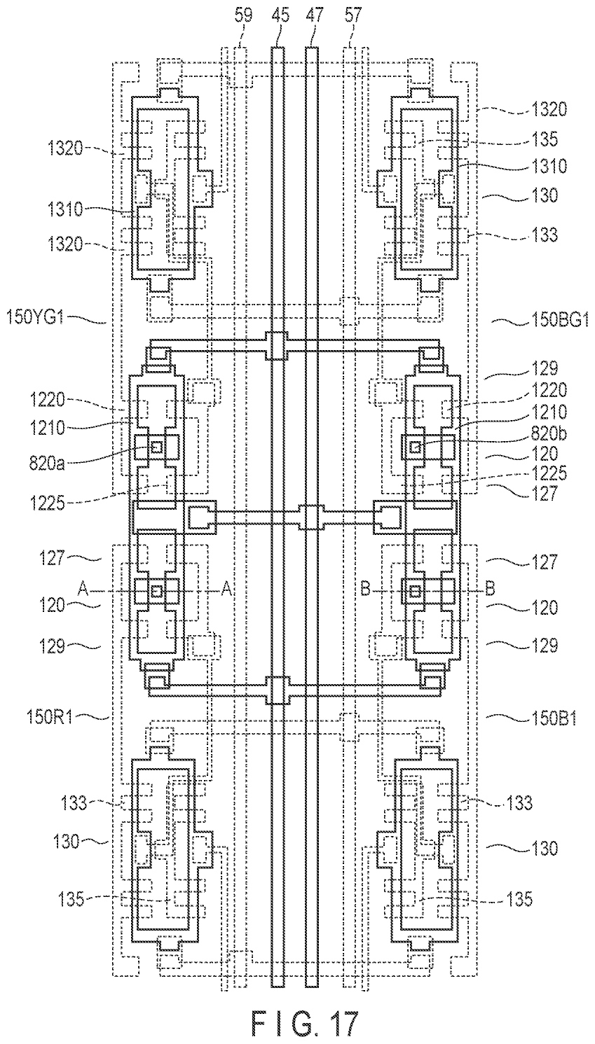

FIG. 17 shows the layout of the circuits to explain the position of the through-hole 820. The layouts of the pixel drive switch circuit 120 and the pixel memory circuit 130 are shown, in which, in the drawing, the top left corresponds to the pixel electrode 150YG1, the top right corresponds to the pixel electrode 150BG1, the bottom left corresponds to the pixel electrode 150R1, and the bottom right corresponds to the pixel electrode 150B1.

The pixel memory circuit 130 is configured by the inverter circuits 133 and 135. A semiconductor layer 1310 is formed in a ring shape in common with the inverter circuits 133 and 135, the output of the inverter circuit 133 is connected to the input of the inverter circuit 135, a gate electrode 1320 of the inverter circuit 133 is connected to a gate electrode 1220 of one of the transfer gates 127 and 129, and the output of the inverter circuit 133 and the input of the inverter circuit 135 are connected to a gate electrode 1225 which is a gate electrode of one of the other transfer gates 127 and 129.

Although a semiconductor layer 1210 is also formed in a ring shape in the pixel drive switch circuit 120, in the pixel drive switch circuit 120 corresponding to the pixel electrodes 150YG1 and 150R1, a through hole 820a is formed at a position of a hole in the ring of the semiconductor layer 1210 in a manner not to overlap with the semiconductor layer 1210. In contrast, in the pixel drive switch circuit 120 corresponding to the pixel electrodes 150BG1 and 150B1, a through hole 820b is moved from the center of the ring of the semiconductor layer 1210 to the side of the pixel electrodes 150YG1 and 150R1. The through-hole 820b is formed at a position overlapping the semiconductor layer 1210.

By moving the through-hole 820b to a position where it overlaps with the semiconductor layer 1210, a margin can be provided at the position where the pixel electrode 150BG1 and the pixel electrode 150B1 are connected.

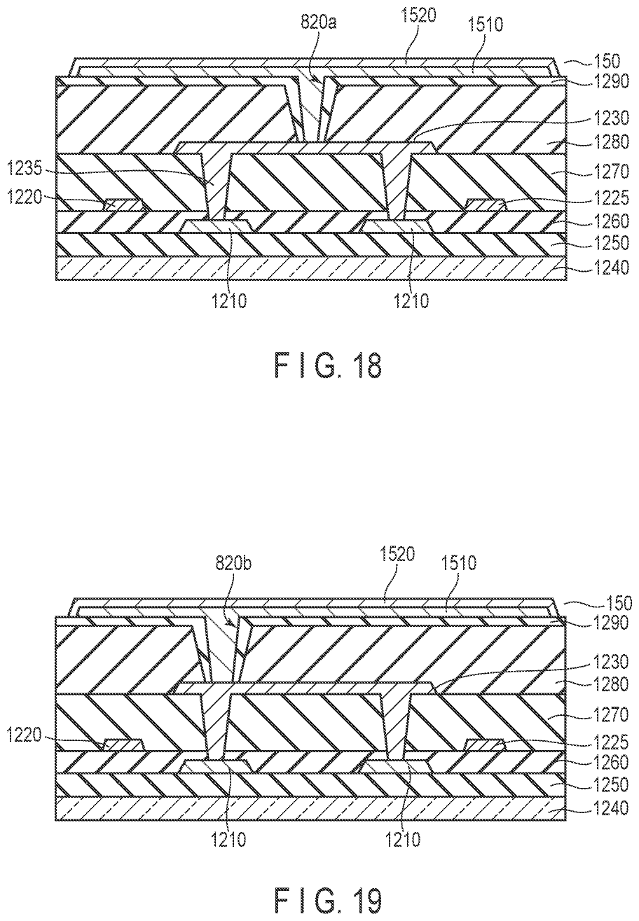

FIG. 18 shows a cross-sectional view of line A-A in FIG. 17. The pixel electrode 150 is formed by a reflective electrode 1510 formed of aluminum or the like and a transparent electrode 1520 formed of ITO or the like, covering the reflective electrode 1510.

Symbol 1240 is a substrate formed of glass, resin, or the like. A base film 1250 formed of SiO or SiN is formed on the substrate 1240, and a semiconductor layer 1210 is formed in a ring shape on the base film 1250. An insulating film 1260 is formed on the semiconductor layer 1210, and gate electrodes 1220 and 1225 of the pixel drive switch circuit 120 are formed on the insulating film 1260.

An insulating film 1270 is formed on the gate electrodes 1220 and 1225, and a relay electrode 1230 is formed on the insulating film 1270. Through holes 1235 are formed in the insulating films 1270 and 1260 to connect the relay electrode 1230 with the gate electrodes 1220 and 1225.

An insulating film 1280 is formed on the relay electrode 1230, and a through hole 820a is formed in the insulating film 1280 to connect the relay electrode 1230 to the reflective electrode 1510.

In the cross section A-A shown in FIG. 18, the through hole 820a is formed near the middle of the ring-shaped semiconductor layer 1210, while in the cross section B-B shown in FIG. 19, a through hole 820b is formed at a position biased from the center to one of the semiconductor layers 1210 so as to overlap with one of the ring-shaped semiconductor layers 1210.

As explained above, according to the present embodiment, when in the memory mode, the system control circuit 380 is used to output a signal to control the polarity signal, and the video signal control circuit 310 is stopped, thereby providing a liquid crystal display device excelling in saving power consumption.

Based on the display device which has been described in the above-described embodiments, a person having ordinary skill in the art may achieve a display device with an arbitral design change; however, as long as they fall within the scope and spirit of the present invention, such a display device is encompassed by the scope of the present invention.

A skilled person would conceive various changes and modifications of the present invention within the scope of the technical concept of the invention, and naturally, such changes and modifications are encompassed by the scope of the present invention.

For example, if a skilled person adds/deletes/alters a structural element or design to/from/in the above-described embodiments, or adds/deletes/alters a step or a condition to/from/in the above-described embodiment, as long as they fall within the scope and spirit of the present invention, such addition, deletion, and altercation are encompassed by the scope of the present invention. Furthermore, regarding the present embodiments, any advantage and effect those will be obvious from the description of the specification or arbitrarily conceived by a skilled person are naturally considered achievable by the present invention.

What is claimed is:

1. A liquid crystal display device comprising:
a liquid crystal panel comprising a pixel and a polarity signal output circuit, the pixel comprising a pixel memory, the polarity signal output circuit being controlled by a polarity control signal and being configured to supply a polarity signal to the pixel; and
a controller configured to supply a video signal and the polarity control signal to the liquid crystal panel, wherein
the liquid crystal panel comprises:
a first mode that displays video using the video signal continuously supplied from the controller; and
a second mode that displays video using the video signal recorded in the pixel memory,
the controller comprises:
a video signal control circuit configured to output the video signal; and
a microcomputer configured to control the video signal control circuit, and
in the first mode, the video signal control circuit outputs the polarity control signal, and in the second mode, the microcomputer outputs the polarity control signal.

2. The liquid crystal display device of claim 1, wherein:
the first mode comprises a mode that is applied when displaying a moving image; and
the second mode comprises a mode applied when displaying a still image.

3. The liquid crystal display device of claim 1, wherein the video signal control circuit is stopped when the liquid crystal panel is in the second mode.

4. The liquid crystal display device of claim 3, wherein the microcomputer is configured to stop the video signal control circuit when the liquid crystal panel switches from the first mode to the second mode.

5. The liquid crystal display device of claim 4, wherein the microcomputer is configured to start outputting the polarity control signal when the liquid crystal panel switches from the first mode to the second mode.

6. The liquid crystal display device of claim 4, wherein the microcomputer is configured to activate the video signal control circuit when the liquid crystal panel switches from the second mode to the first mode.

7. The liquid crystal display device of claim 6, wherein the microcomputer is configured to stop output the polarity control signal when the liquid crystal panel switches from the second mode to the first mode.

8. The liquid crystal display device of claim 1, wherein the controller comprises a circuit configured to exclusively and selectively output the polarity control signal from the video signal control circuit or the polarity control signal from the microcomputer to the liquid crystal panel, and to invalidate a polarity control signal erroneously output from the video signal control circuit when the liquid crystal panel switches from the first mode to the second mode or from the second mode to the first mode.

9. The liquid crystal display device of claim 3, wherein the controller comprises a first power source voltage circuit configured to generate a voltage for operating the video signal control circuit, and
the first power source voltage circuit is stopped when the liquid crystal panel is in the second mode.

10. The liquid crystal display device of claim 9, wherein:
the liquid crystal panel comprises a video signal output unit configured to output the video signal supplied by the controller to a video signal line to which the pixel is connected;
the controller comprises a second power source voltage circuit configured to generate a voltage for operating the video signal output unit; and
the second power source voltage circuit is stopped when the liquid crystal panel is in the second mode.
